(19) United States
(12) Patent Application Publication
(10) Pub. No.: US 2024/0054618 A1
(43) Pub. Date: Feb. 15, 2024

(54) METHOD AND APPARATUS WITH IMAGE PROCESSING BASED ON A NEURAL NETWORK

(71) Applicant: SAMSUNG ELECTRONICS CO., LTD., Suwon-si (KR)

(72) Inventors: Kinam KWON, Suwon-si (KR); Jaehyoung YOO, Suwon-si (KR); Junsang YU, Suwon-si (KR); Sangwon LEE, Suwon-si (KR); Hyong Euk LEE, Suwon-si (KR)

(73) Assignee: SAMSUNG ELECTRONICS CO., LTD., Suwon-si (KR)

(21) Appl. No.: 18/337,899

(22) Filed: Jun. 20, 2023

(30) Foreign Application Priority Data
Aug. 11, 2022 (KR) 10-2022-0100743

(51) Int. Cl. G06T 5/00; G06T 1/20; G06V 10/82

(52) U.S. Cl. CPC G06T 5/002; G06T 1/20; G06V 10/82

(57) ABSTRACT

A neural network-based image processing method and apparatus are provided. A method includes receiving input image data comprising original image data, when a current image processing mode is an independent processing mode, generating first intermediate image data by executing a main neural network based on the original image data and by not executing an auxiliary neural network based on the original image data, when the current image processing mode is in a cooperative processing mode, generating second intermediate image data by determining an auxiliary parameter by executing the auxiliary neural network based on the original image data and by executing the main neural network based on the original image data and based on the auxiliary parameter, and generating output image data by operating an image signal processing (ISP) block based the first intermediate image data or the second intermediate image data according to the current image processing mode.

### CROSS-REFERENCE TO RELATED APPLICATIONS

This application claims the benefit under 35 USC § 119(a) of Korean Patent Application No. 10-2022-0100743, filed on Aug. 11, 2022, in the Korean Intellectual Property Office, the entire disclosure of which is incorporated herein by reference for all purposes.

### BACKGROUND

### 1 Field

The following description relates to a method and an apparatus with image processing based on a neural network.

### 2. Description of Related Art

Recently, various methods have been used for deep learning-based neural networks for image processing. A neural network may be trained based on deep learning, and then perform inference for the desired purpose by mapping input data and output data that are in a nonlinear relationship to each other. Such a trained capability of generating the mapping may be referred to as a learning ability of the neural network. The neural network trained for a special purpose, such as image restoration, may have a general ability to generate a relatively accurate output in response to an input pattern that is not yet trained.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of image processing based on a neural network includes: receiving input image data comprising original image data, when a current image processing mode is an independent processing mode, generating first intermediate image data by executing a main neural network based on the original image data and by not executing an auxiliary neural network based on the original image data, when the current image processing mode is in a cooperative processing mode, generating second intermediate image data by determining an auxiliary parameter by executing the auxiliary neural network based on the original image data and by executing the main neural network based on the original image data and based on the auxiliary parameter, and generating output image data by operating an image signal processing (ISP) block based the first intermediate image data or the second intermediate image data according to the current image processing mode.

The main neural network may be configured to constitute a stage of an ISP pipeline that performs an image restoration characteristic, and the ISP block may be configured to constitute another stage of the ISP pipeline having an image enhancement characteristic.

The method may further include determining the current image processing mode according to a required processing level for the input image data.

The determining of the current image processing mode may include changing the current image processing mode to the independent processing mode when the input image data is used as a preview or a video, and changing the current image processing mode to the cooperative processing mode when the input image data is stored as a capturing result.

The auxiliary neural network may include sub-neural networks each configured to generate respective different sub-parameters of the auxiliary parameter.

The sub-neural networks may include a sub-neural network configured to generate a sub-parameter representing an optical diffraction state, a blur state, a detail noise state, a detail white balance state, detail of a high dynamic range (HDR) state, or a degree of resource input according to a required calculation amount, and the sub-neural networks may be configured to be selectively executed according to a required processing level for the input image data.

The auxiliary neural network may include a sub-neural network configured to generate a degradation sub-parameter representing an optical diffraction state of the input image data or a blur state of the input image data, where the degradation sub-parameter may be configured to specify a degradation type of the input image data or a degradation level of the input image data, and where the main neural network may be configured to generate the second intermediate image data in consideration of the degradation type of the input image data or the degradation level of the input image data according to the degradation sub-parameter in the cooperative processing mode.

The auxiliary neural network may include a sub-neural network configured to generate a degradation sub-parameter representing an optical diffraction state of the input image data or a blur state of the input image data, and the method may further include generating third intermediate image data by executing a degradation restoration network based on the second intermediate image data and the degradation sub-parameter in the cooperative processing mode, and where the generating of the output image data may include generating the output image data by operating the ISP block based on the third intermediate image data.

The auxiliary neural network may include a sub-neural network configured to generate a noise sub-parameter representing a detail noise state of the input image data, where the noise sub-parameter may be configured to specify a noise type of the input image data or a noise level of the input image data, and where the main neural network may be configured to generate the second intermediate image data in consideration of the noise type of the input image data or the noise level of the input image data according to the noise sub-parameter in the cooperative processing mode.

The input image data may further include metadata having information on a noise state of the input image data, and the noise sub-parameter may be configured to represent the noise state of the input image data with finer granularity than the metadata.

The auxiliary neural network may include a sub-neural network configured to generate an enhancement sub-parameter representing a detail white balance state of the input image data or detail of an HDR state of the input image data, and the generating of the output image data may include operating the ISP block by inputting the enhancement sub-parameter into the ISP block.

The auxiliary neural network may include a sub-neural network configured to generate a calculation sub-parameter representing a degree of resource input according to a required calculation amount of the input image data, and an operation degree of the main neural network or the ISP block may be determined by the calculation sub-parameter.

The auxiliary neural network may include sub-neural networks configured to generate a respective sub-parameters of the auxiliary parameter, and the sub-neural networks may be configured to generate the sub-parameters in parallel.

The main neural network may be configured to be executed by a first processing element, the sub-neural networks may be configured to be executed by a sub-processing element of a second processing element; and the first processing element, the second processing element, and the ISP block may be distinct hardware elements.

In one general aspect, an image processing apparatus includes: a processing block configured to receive input image data comprising original image data, where, when a current image processing mode of the apparatus is an independent processing mode, generate first intermediate image data by executing a main neural network based on the original image data and by not executing an auxiliary neural network based on the original image data, where, when the current image processing mode of the apparatus is in a cooperative processing mode, extract an auxiliary parameter by executing the auxiliary neural network based on the original image data, generate second intermediate image data by executing the main neural network based on the original image data and based on the auxiliary parameter, and an ISP block configured to generate output image data based on the first intermediate image data when the current image processing mode is the independent processing mode, and generate the output image data based on the second intermediate image data when the current image processing mode is the cooperative processing mode.

The apparatus may be further configured to change the current image processing mode to the independent processing mode when the input image data is used as a preview or a video and change the current image processing mode to the cooperative processing mode when the input image data is stored as a capturing result.

The auxiliary neural network may include sub-neural networks each configured to respectively generate different sub-parameters of the auxiliary parameter.

The sub-neural networks of the auxiliary neural network may include a sub-neural network configured to generate a sub-parameter representing an optical diffraction state, a blur state, a detail noise state, a white balance state, an HDR state, or a degree of resource input according to a required calculation amount, and the sub-neural networks may be configured to be selectively executed according to a required processing level for the input image data.

In one general aspect, a method includes executing an ISP pipeline comprising a main neural network stage, an ISP stage, and an auxiliary neural network stage, the image processing pipeline configured to alternate between operating in a first mode and a second mode, when the image processing pipeline is operating in the first mode and when the image processing pipeline is operating in the second mode: generating, by the main neural network stage, intermediate images based on the respective input images, and providing the intermediate images to the ISP stage, when the pipeline is in the second mode and is not in the first mode: processing the input images by the auxiliary neural network stage to generate respective auxiliary parameters, and providing the auxiliary parameters to the main neural network stage as an additional basis used by the main neural network stage to generate the intermediate images.

The main neural network stage may not generate the intermediate images based on the auxiliary parameters when the image processing pipeline is in the first mode, the main neural network stage may perform image restoration on the input images to generate the intermediate images, and the ISP stage may perform image enhancement on the intermediate images.

Other features and aspects will be apparent from the following detailed description, the drawings, and the claims.

### BRIEF DESCRIPTION OF THE DRAWINGS

FIG. 1 illustrates an example of an image processing structure for multiple image processing modes, according to one or more embodiments.

FIG. 2 illustrates an example of an image processing structure in which an auxiliary parameter is provided from an auxiliary neural network to a main neural network, according to one or more embodiments.

FIG. 3 illustrates an example of an image processing structure in which an auxiliary parameter is provided from an auxiliary neural network to an additional neural network, according to one or more embodiments.

FIG. 4 illustrates an example of an image processing structure in which an auxiliary parameter is provided from an auxiliary neural network to an image signal processing (ISP) block, according to one or more embodiments.

FIG. 5 illustrates an example of an image processing paths through sub-neural networks in a cooperative processing mode, according to one or more embodiments.

FIG. 6 illustrates an example configuration of an image processing apparatus, according to one or more embodiments.

FIG. 7 illustrates an example configuration of an electronic device, according to one or more embodiments.

FIG. 8 illustrates an example image processing method based on a neural network, according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

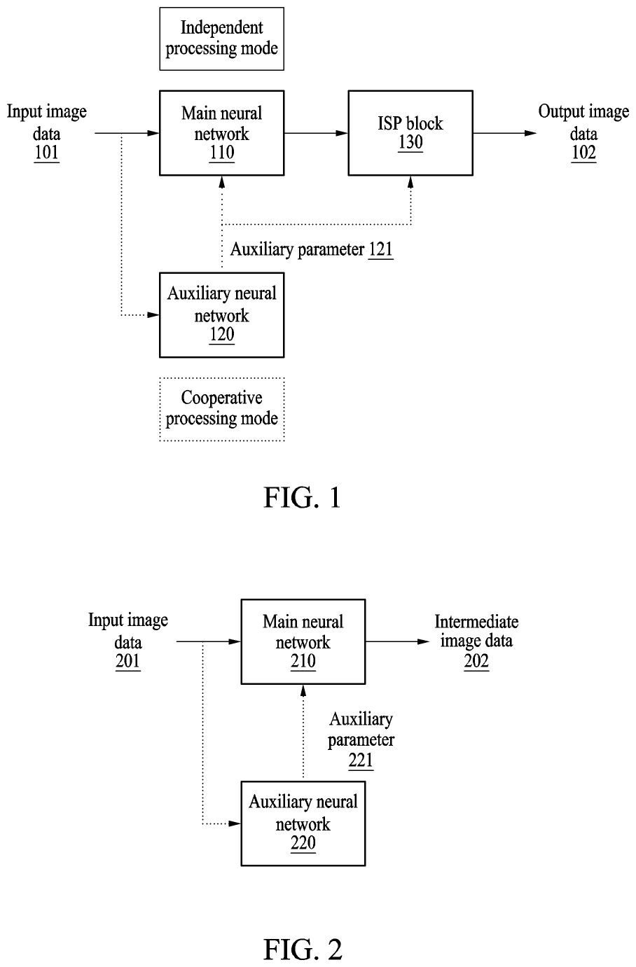

FIG. 1 illustrates an example of an image processing structure for multiple image processing modes, according to one or more embodiments. The image processing apparatus may generate output image data 102 corresponding to input image data 101 by using a main neural network 110, an auxiliary neural network 120, and an image signal processing (ISP) block 130. The input image data 101 may include original image data and in some embodiments may also include metadata. The original image data may include visual information of a captured scene (e.g., pixel data) and the metadata may include environment information related to the capturing of the original image data. For example, the original image data may include raw image data and the metadata may include information related to a noise state, a white balance state, a high dynamic range (HDR) state, and the like, e.g., a setting of an image capture device when the original image data was captured.

The input image data 101 may be provided from various image sensing devices such as a camera. For example, the input image data 101 may be transmitted from an image sensor of the image sensing device. The original image data may have a format that may pass through an ISP pipeline and be provided for end-use, e.g., transmission, storage, display, etc. For example, the ISP pipeline may include various image processing stages for functions such as demosaicing, denoising, deblurring, white balancing, gamma correction, and color transform on the original image data.

The main neural network 110 and/or the auxiliary neural network 120 may be responsible for a portion or stage of the ISP pipeline and the ISP block 130 may be responsible for another portion or stage of the ISP pipeline. For example, the main neural network 110 and/or the auxiliary neural network 120 may constitute a portion or stage having an image restoration characteristic of the ISP pipeline and the ISP block 130 may constitute another portion or stage having an image enhancement characteristic of the ISP pipeline. For example, demosaicing, denoising, and deblurring may be image restoration characteristics and white balancing, gamma correction, and color transformation may be image enhancement characteristics. Since image restoration-related calculations are often complex and may be normalized and thus a neural network calculation for image restoration may be suitable, and image enhancement-related calculations may be suitable for hardware signal processing (or acceleration) due to typically simple and subjective characteristics (and thus may be performed with filters, kernels, or the like without the use of a neural network).

The main neural network 110 and/or the auxiliary neural network 120 may be implemented through respective neural network models. After being trained based on machine learning, the neural networks may perform inferences suitable for the purpose of the training by mapping input data and output data that are in a nonlinear relationship to each other. A structure of a neural network model or a weight corresponding to the neural network model may be obtained through supervised learning or unsupervised learning and the input data and the output data may be mapped based on the weight.

The ISP block 130 may correspond to hardware and may implement portion(s) of the ISP pipeline through hardware signal processing (generally, not as neural networks). When the ISP pipeline is implemented with both the neural networks 110 and 120 and the ISP block 130, the performance improvement through the neural networks 110 and 120 may be achieved while maintaining compatibility with existing functions of the ISP block 130 by simultaneously utilizing a deep learning-based neural network and signal processing hardware.

The image processing apparatus may include an independent processing mode and a cooperative processing mode. The independent processing mode may correspond to an image processing mode in which the main neural network 110 is used independently (the auxiliary neural network 120 is not used) to process the original image data of a given original input image. The cooperative processing mode may correspond to an image processing mode in which the main neural network 110 and the auxiliary neural network 120 cooperate with each other. In some embodiments the main neural network 110 and the auxiliary neural network 120 cooperate in that both networks process the same original image data of a given original input image when the cooperative processing mode is in effect; in some embodiments the auxiliary characteristic output by the auxiliary neural network may be provided to the main neural network, which the main neural network uses to generate intermediate image data from the same original image data.

When the current image processing mode is the independent processing mode, an image processing apparatus may independently use the main neural network 110. The image processing apparatus may generate intermediate image data by executing the main neural network 110 based on the original image data. The intermediate image data may correspond to an output of the main neural network 110. For example, the intermediate image data may correspond to linear red, green, and blue (RGB) data and the output image data 102 may correspond to standard RGB (sRGB) data. In the RGB data and the sRGB data, “RGB” may mean “red, green, and blue” (other color schemes/spaces may be used).

When the current image processing mode is the cooperative processing mode, the image processing apparatus may use the main neural network 110 and the auxiliary neural network 120 together. The image processing apparatus may determine the auxiliary parameter 121 by executing the auxiliary neural network 120 based on the original image data of a given original input image. The image processing apparatus may execute the main neural network 110 based on the same original image data and based on the auxiliary parameter 121. The image processing apparatus may generate intermediate image data for the given original input image by determining the auxiliary parameter 121 thereof and by executing the main neural network 110 based on the original image data of the given input image (e.g., receiving it at an input layer) and based on the auxiliary parameter 121.

The intermediate image data generated in the independent processing mode may be referred to as first intermediate image data and the intermediate image data generated in the cooperative processing mode may be referred to as second intermediate image data. The image processing apparatus may generate the output image data 102 by operating the ISP block 130 based either the first intermediate image data or the second intermediate image data, according to the current image processing mode. That is, the ISP block 130 may operate on the intermediate image data generated by the main neural network (first or second) regardless of which mode is the current image processing mode.

The image processing apparatus may determine or select the current image processing mode according to a required processing level for the input image data 101, for example. For example, the required processing level may vary according to a purpose of the input image data 101. For example, the image processing apparatus may select the current image processing mode as the independent processing mode based on determining that the input image data 101 is used as a preview or a video. The image processing apparatus may select the current image processing mode as the cooperative processing mode based on determining that the input image data is to be stored as a capturing result. Any basis of mode selection may be used.

When the current image processing mode is the cooperative processing mode, the auxiliary neural network 120 may generate the auxiliary parameter 121 based on the input image data 101 (e.g., received at an input layer of the auxiliary neural network 120) and the thus-generated auxiliary parameter 121 may be provided to the main neural network 110 and/or the ISP block 130. Here, “based on the input image data” includes receiving input original input image data of an original input image (or a version thereof that may have been processed earlier in the pipeline, etc.) The auxiliary neural network 120 and the main neural network 110 may receive same original input image data 101 or different versions of the original input image data 101. The auxiliary parameter 221 may correspond to an output of the auxiliary neural network 220. The auxiliary parameter 221 may include one or more parameter values. For example, the auxiliary parameter 221 may have a data form such as a scalar, a flag (possibly a single bit), a vector, a matrix, or combinations thereof (in which case the auxiliary parameter 221 may be a data structure of various possible forms). Each parameter value may be expressed as single-bit or multiple bits. The auxiliary parameter 121 may have a small size compared to the input image data 101. The auxiliary neural network 120 may efficiently guide an image processing process of the input image data 101 (e.g., by the main neural network and/or by the ISP block) by summarizing characteristics of the input image data 101 in the auxiliary parameter 121 in a low amount of information.

The auxiliary neural network 220 may include one or more sub-neural networks and each sub-neural network may output at least one respective sub-parameter. The auxiliary parameter 221 may include at least one such sub-parameter. For example, the auxiliary neural network 120 may include sub-neural networks, each generating different respective sub-parameters of the auxiliary parameter 121. Each sub-neural network may perform an additional function according to a certain scenario or application associated with an original input image being processed by the ISP pipeline. For example, sub-neural networks may respectively generate sub-parameters representing an optical diffraction state, a blur state, a detail noise state, a detail white balance state, a detail high dynamic range (HDR) state, and a degree of resource input according to a required calculation amount, to name some examples. In some embodiments there is only one sub-neural network and there is only one sub-parameter, which is the entirety of the auxiliary parameter 121. Sub-neural networks may be swapped in and out (or activated/deactivated) as needed for different scenarios and applications.

The sub-neural networks may be selectively executed according to a required processing level for the input image data 101, for example. For example, the required processing level may be (or be based on) a quality of the input image data 101 and/or a user preference, for example. For example, when the input image data 101 has little noise, a sub-neural network model for estimating the detail of the noise state may be deactivated, and when the input image data 101 has significant blur, a sub-neural network model estimating the blur state may be activated. In addition, a certain sub-neural network may be activated or deactivated according to a user preference. The auxiliary neural network 120 may operate as an add-on of the main neural network 110 and/or the ISP block 130 through the sub-neural networks that are selectively executed/activated. In this way, a sensor correction or an additional function may be processed efficiently. In addition, the auxiliary neural network 120 may be extended to various fields in which artificial intelligence technology is extended (in the future) through the sub-neural networks (i.e., new sub-neural networks may be added).

The sub-neural networks of the auxiliary neural network 120 may be executed independently of each other. The sub-neural networks may be processed in parallel. In addition, in some embodiments, the sub-neural networks may be processed in parallel with the main neural network 110. The parallel processing of the sub-neural networks may reduce the generation time of sub-parameters and the waiting time of the main neural network 110.

The main neural network 110 and the sub-neural networks may be executed by different hardware processing elements. For example, the main neural network 110 may be executed by a first processing element (e.g., a neural processing unit (NPU) or processing element thereof) and the sub-neural networks may be executed by a second processing element (e.g., a graphic processing unit (GPU), a second NPU, or a second processing element of the first NPU). When the second processing element includes sub-processing elements, each sub-neural network may be processed in parallel by a respective sub-processing element.

FIG. 2 illustrates an example of an image processing structure in which an auxiliary parameter is provided from an auxiliary neural network to a main neural network, according to one or more embodiments. Referring to FIG. 2, the auxiliary neural network 220 may generate the auxiliary parameter 221 based on input image data 201. The auxiliary parameter 221 may be input to a main neural network 210. The main neural network 210 may generate intermediate image data 202 based on the input image data 201 and based on the auxiliary parameter 221 (when generated, according to the current mode). The input image data 201 and the auxiliary parameter 221 may be input to the same layer or different layers of the main neural network 210 and may affect the process of generating the intermediate image data 202 by the main neural network 210. For example, the input image data 201 of a given input image may be provided to an input layer of the main neural network 210 and the auxiliary parameter 221 may be input to a latent layer of the main neural network 210. The intermediate image data 202 is referred to as “intermediate” for convenience; in some embodiments the main neural network 210 may be a final stage of the ISP pipeline and the intermediate image data 202 may be a final output image data of the ISP pipeline.

In some embodiments, the auxiliary neural network 220 may include sub-neural networks, which are selectively activated as needed for respective input image data (or input images). For example, the auxiliary neural network 220 may include a sub-neural network that generates a degradation sub-parameter representing of an optical diffraction state of the input image data 201 and/or a blur state of the input image data 201. The degradation sub-parameter may specify a degradation type of the input image data 201 and/or a degradation level of the input image data 201. For example, the degradation type may include a lens distortion type and/or a blur type, and the degradation level may represent the intensity of each degradation type. In the cooperative processing mode, the main neural network may generate the intermediate image data 202 in consideration of the degradation type of the input image data 201 and/or the degradation level of the input image data 201 according to the degradation sub-parameter. For example, as with the other examples, activations of nodes of the main neural network when processing the input image data of a given input image may depend on the degradation sub-parameter generated for the same input image data of the given input image.

According to some embodiments, the auxiliary neural network 220 may include a sub-neural network that generates a noise sub-parameter representing detail of a noise state of the input image data 201. The noise sub-parameter may specify or indicate a noise type of the input image data 201 and/or a noise level of the input image data 201. In the cooperative processing mode, the main neural network 210 may generate the intermediate image data 202 in consideration of the noise type of the input image data 201 and/or the noise level of the input image data 201 indicated by the noise sub-parameter. For example, activations of nodes of the main neural network when processing the input image data of a given input image may depend on the noise sub-parameter computed for the input image of the given input image.

The input image data 201 may include metadata regarding a capturing environment or setting associated with capturing of the input image data 201. The metadata may include information on the noise state of the input image data 201. The noise sub-parameter may represent a more granular noise state of the input image data 201 than the metadata. For example, the metadata may represent the noise state of the entire image frame and the noise sub-parameter may represent the noise state in units smaller than the entire image frame, such as a single pixel or a pixel block. The enhancement sub-parameter may represent a noise state in the form of a map corresponding to the input image data 201. For example, activations of nodes of the main neural network when processing the input image data of a given input image may depend on the noise sub-parameter calculated for the input image data of the given input image.

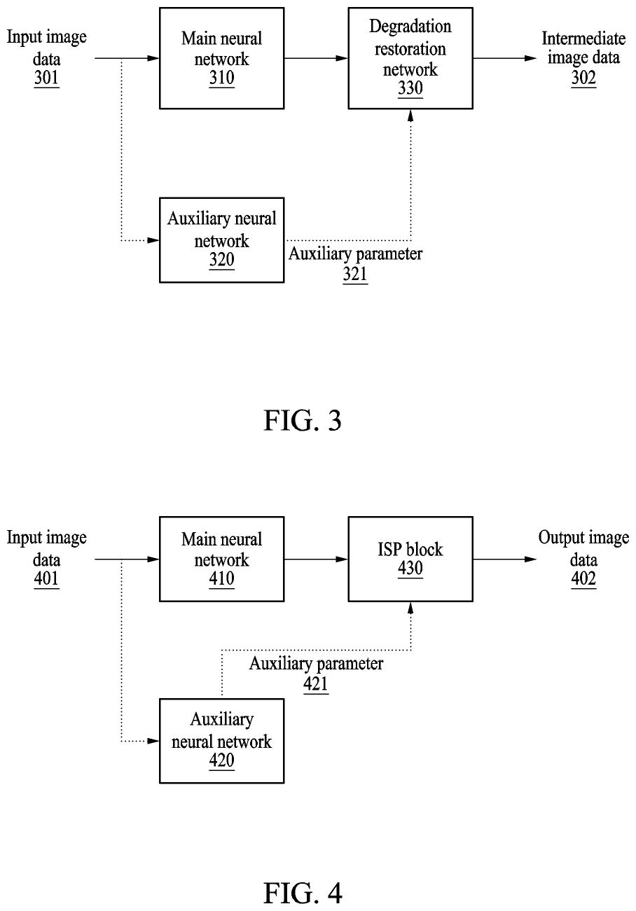

FIG. 3 illustrates an example of an image processing structure in which an auxiliary parameter is provided from an auxiliary neural network to an additional neural network, according to one or more embodiments. Referring to FIG. 3, an auxiliary neural network 320 may generate an auxiliary parameter 321 based on input image data 301, as described above. The auxiliary parameter 321 may be input to a degradation restoration network 330. The degradation restoration network 330 may receive output data of a main neural network 310 as an input and generate intermediate image data 302. In this process, the degradation restoration network 330 may perform degradation restoration on the output data of the main neural network 310 based on the auxiliary parameter 321. The output data and the auxiliary parameter 321 may be input to the same layer or different layers of the degradation restoration network 330 and may affect the process of generating the intermediate image data 302 by the degradation restoration network 330.

According to some embodiments, the auxiliary neural network 320 may include a sub-neural network that generates a degradation sub-parameter representing an optical diffraction state of the input image data 301 and/or a blur state of the input image data 301. In the cooperative processing mode, the image processing apparatus may generate the intermediate image data 302 by executing the degradation restoration network 330 based on the output data of the main neural network 310 and the degradation sub-parameter of the sub-neural network. The main neural network 310 and the auxiliary neural network 320 may execute in parallel. The image processing apparatus may generate a final result by operating the ISP block based on the intermediate image data 302. In other words, the neural network-based restoration processing and the auxiliary-network processing for a given input image may be performed on two different versions of the given input image.

In some embodiments, unlike FIG. 3, the auxiliary parameter 321 may be provided to both the main neural network 310 and the degradation restoration network 330. In this case, the main neural network 310 may generate output data based on the input image data 301 and the auxiliary parameter 321, and the degradation restoration network 330 may generate the intermediate image data 302 based on the output data and the auxiliary parameter 321.

FIG. 4 illustrates an example of an image processing structure in which an auxiliary parameter is provided from an auxiliary neural network to an ISP block, according to one or more embodiments. The ISP block may be a known type of ISP block and may not be a neural network (e.g., the ISP block may be an image processing kernel). Referring to FIG. 4, an auxiliary neural network 420 may generate an auxiliary parameter 421 based on input image data 401. The auxiliary parameter 421 may be input to an ISP block 430 (and not the main neural network 410). The ISP block 430 may operate an ISP pipeline stage based on the auxiliary parameter 421. For example, the ISP block 430 may control a control element of the ISP pipeline, such as an adjustment threshold based on the auxiliary parameter 421. When the intermediate image data is generated by a main neural network 410, the ISP block 430 may generate output image data 402 by processing the intermediate image data based on the auxiliary parameter 421.

According to some embodiments, the auxiliary neural network 420 may include a sub-neural network that generates an enhancement sub-parameter representing at least a portion of a detail white balance state of the input image data and a detail HDR state of the input image data. The image processing apparatus may operate the ISP block 430 by inputting the enhancement sub-parameter to the ISP block 430. Note that although the term sub-neural network is used herein to refer to various auxiliary neural network image processing, the term “sub” does not imply that there are always multiple neural networks to be selected among for activation. In some embodiments, there is only one auxiliary neural network, which, for brevity of description, may be referred to as a sub-neural network even though there are no other networks provided for auxiliary processing.

The input image data 401 may include metadata regarding a capturing environment of the input image data 401. The metadata may include information on a white balance state and/or an HDR state of the input image data 401. The enhancement sub-parameter may represent a white balance state and/or an HDR state of the input image data 401 according to a unit area of the input image data 401 that is more granular than the metadata. For example, the metadata may represent each state in units of the entire image frame (or large blocks thereof) and the enhancement sub-parameter may represent each state in units smaller than the entire image frame (or smaller blocks), such as a single pixel or a pixel block. The enhancement sub-parameter may represent state of each unit in the form of a map corresponding to the input image data 401.

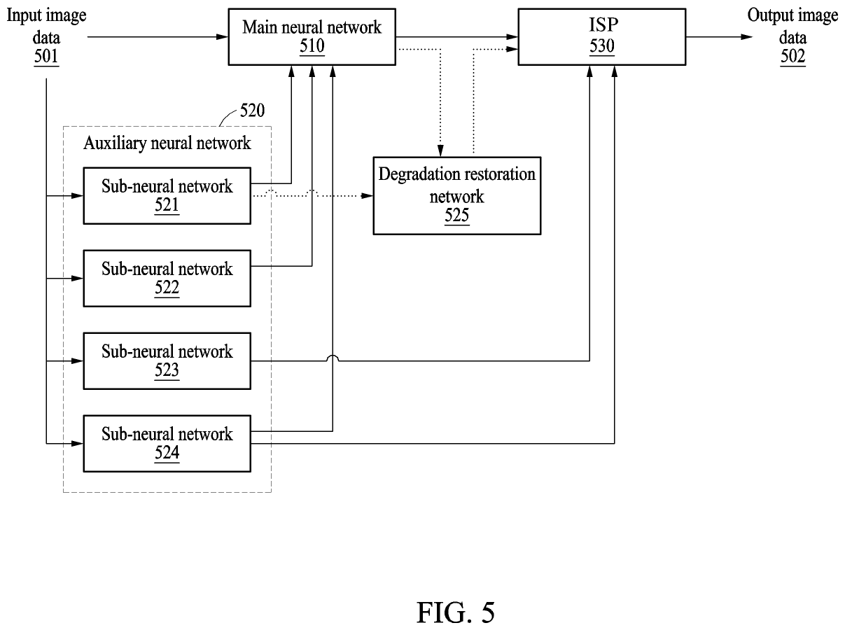

FIG. 5 illustrates an example of an image processing paths through sub-neural networks in a cooperative processing mode, according to one or more embodiments. Referring to FIG. 5, an auxiliary neural network 520 may determine an auxiliary parameter based on input image data 501 and a main neural network 510 may generate intermediate image data based on the input image data 501 and the auxiliary parameter. An ISP block 530 may generate output image data 502 based on the intermediate image data.

The auxiliary neural network 520 may include sub-neural networks 521 to 524. In some embodiments, a sub-neural network 521 may generate a degradation sub-parameter representing an optical diffraction state of the input image data 501 and/or a blur state of the input image data 501. The sub-neural network 521 may correspond to a degradation estimation network.

When a deblur kernel is provided or feasible (a non-neural network image processing kernel in the image processing pipeline, e.g., and ISP block), for example, in the case of a known case or non-blind blur, the sub-neural network 521 may be deactivated. When a deblur kernel is not provided or feasible, for example, in the case of an unknown case or blind blur, the sub-neural network 521 may be activated and may estimate the degradation sub-parameter in the active state.

When a degradation restoration network 525 is not used, the degradation sub-parameter may be provided to the main neural network 510. The main neural network 510 may generate intermediate image data based on the input image data 501 and the degradation sub-parameter. The intermediate image data may be provided to the ISP block 530. When the degradation restoration network 525 is used, the degradation sub-parameter may be provided to the main neural network 510 and/or the degradation restoration network 525. The main neural network 510 may generate output data based on the input image data 501 or based on the input image data 501 and the degradation sub-parameter. The degradation restoration network 525 may generate intermediate image data based on the output data of the main neural network 510 and the degradation sub-parameter of the sub-neural network 521. The intermediate image data may be provided to the ISP block 530. The Wiener deconvolution may be used for the deblur calculation of the main neural network 510 and/or the degradation restoration network 525.

One or more deblur kernels may exist. For example, one deblur kernel may correspond to uniform blur or spatially invariant blur. For example, several deblur kernels may correspond to nonuniform blur or spatially variant blur. The degradation element may be variously expandable to degradation functions other than optical diffraction and blur, and the sub-neural network 521 may be additionally utilized for the sensor correction and/or sensor adaptation.

According to some embodiments, a sub-neural network 522 may generate a noise sub-parameter representing detail of a noise state of the input image data 501. The sub-neural network 522 may correspond to a noise estimation network. In order to improve the performance of the main neural network 510, the main neural network 510 may use metadata of the input image data 501 and/or may use the noise sub-parameter of the sub-neural network 522. The sub-neural network 522 may estimate a noise type and/or a noise level using original image data and/or metadata of the input image data 501. The sub-neural network 522 may be further utilized for the sensor correction and/or sensor adaptation.

In some embodiments, the sub-neural network 523 may generate an enhancement sub-parameter representing detail of a white balance state of the input image data 501 and/or detail of an HDR state of the input image data 501. The sub-neural network 523 may correspond to a white balance estimation network and/or an HDR estimation network.

When the sub-neural network 523 estimates detail of a white balance state as a white balance estimation network, the sub-neural network 523 may estimate one lighting value and apply it to the entire image or may estimate a lighting map for each pixel to correspond to multiple light sources. These lighting values and/or lighting maps may be given as an input parameter of a white balance module of the ISP block 530. The sub-neural network 523 may operate as an HDR estimation network in a similar manner. For example, the sub-neural network 523 may estimate an enhancement sub-parameter according to a radiance map and a gamma correction module of the ISP block 530 (or a module performing a tone mapping may perform the HDR using the enhancement sub-parameter).

The sub-neural network 524 may generate a calculation sub-parameter representing a degree of resource input according to a required calculation amount of the input image data 501. The calculation sub-parameter may be provided to the main neural network 510 and/or the ISP block 530. A degree of operation of the main neural network 510 and/or the ISP block 530 may be determined by the sub-neural network 524 and may be indicated by the calculation sub-parameter generated thereby. The sub-neural network 524 may correspond to a calculation-amount estimation network.

When a computing resource is insufficient or when fast calculation is required (e.g., in the independent processing mode), a method of using a branch that outputs data using a portion of the entire main neural network 510 (e.g., some layers of the entire layer) or, in the case of an unfold-type network, a method of performing only partial iterations may be used. The sub-neural network 524 may determine whether to perform early termination of the main neural network 510 or may determine a point at which the early termination is performed. The sub-neural network 524 may designate a skippable module in the ISP block 530. In other words, the sub-neural network 524 may control which IPS modules are used for a given input image.

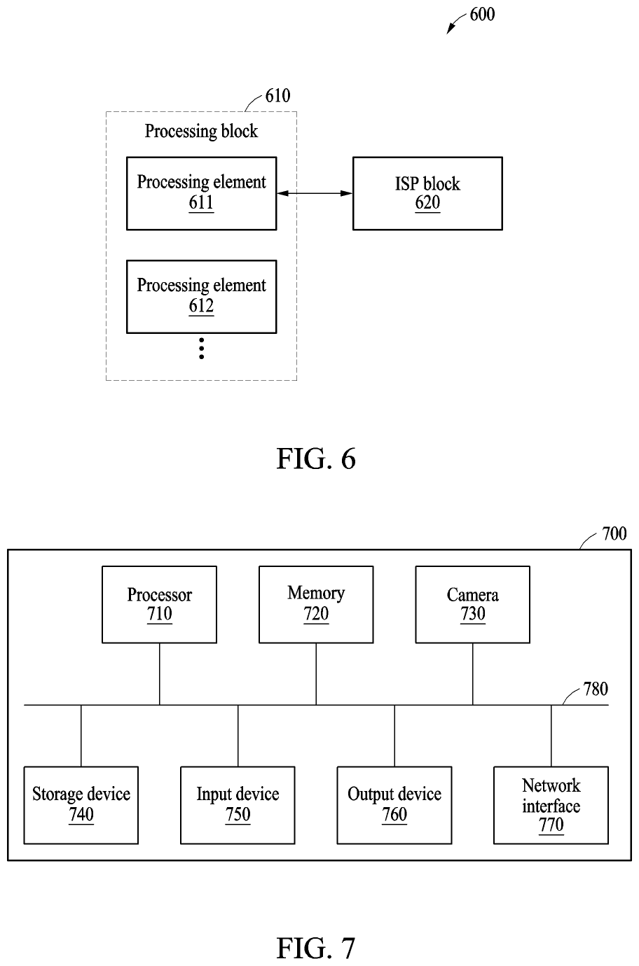

FIG. 6 illustrates an example configuration of an image processing apparatus, according to one or more embodiments. Referring to FIG. 6, an image processing apparatus 600 may include a processing block 610 and an ISP block 620. The processing block 610 may generate second intermediate image data by receiving input image data including original image data, generating first intermediate image data by executing a main neural network based on the original image data when a current image processing mode is an independent processing mode, and by extracting an auxiliary parameter by executing an auxiliary neural network based on the original image data when the current image processing mode is a cooperative processing mode. The image processing apparatus 60 may generate second intermediate image data by executing the main neural network based on the original image data and the auxiliary parameter. The ISP block 620 may generate output image data based on either the first intermediate image data or the second intermediate image data, and may do so according to the current image processing mode.

The processing block 610 may include processing elements 611 and 612. For example, the processing elements 611 and 612 may correspond to a central processing unit (CPU), a graphic processing unit (GPU), a neural processing unit (NPU), and/or a digital signal processor (DSP).

In some embodiments, the main neural network and the auxiliary neural network may be processed independently of each other. For example, the main neural network may be executed by the processing element 611 and the auxiliary neural network may be executed by the processing element 612. The processing element 611, the processing element 612, and the ISP block 620 may be distinct hardware elements (and may be capable of executing in parallel).

In some embodiments, the auxiliary neural network may include sub-neural networks generating sub-parameters of the auxiliary parameter. The sub-neural networks may generate sub-parameters in parallel. For example, the processing element 612 may include sub-processing elements classified from each other as hardware and the sub-neural networks may be processed in parallel by the sub-processing elements.

In addition, the descriptions provided with reference to FIGS. 1 to 5, 7, and 8 may be applied to the image processing apparatus 600.

FIG. 7 illustrates an example configuration of an electronic device, according to one or more embodiments. An electronic device 700 may include a processor 710, a memory 720, a camera 730, a storage device 740, an input device 750, an output device 760, and a network interface 770 that may communicate with each other through a communication bus 780. For example, the electronic device 700 may be embodied as at least a portion of a mobile device (e.g., a mobile phone, a smartphone, a personal digital assistant (PDA), a netbook, a tablet computer, a laptop computer, etc.), a wearable device (e.g., a smartwatch, a smart band, smart eyeglasses, etc.), a computing device (e.g., a desktop, a server, etc.), a home appliance (e.g., a television (TV), a smart TV, a refrigerator, etc.), a security device (e.g., a door lock, etc.), or a vehicle (e.g., an autonomous vehicle, a smart vehicle, etc.). The electronic device 700 may be, or may structurally and/or functionally include, the image processing apparatus 600 of FIG. 6.

The processor 710 may execute instructions and functions in the electronic device 700. For example, the processor 710 may process the instructions stored in the memory 720 or the storage device 740. The processor 710 may perform operations of FIGS. 1 to 6 and 8. The processor 710 may correspond to the processing block 610 of FIG. 6. The memory 720 may include a computer-readable storage medium or computer-readable storage device. The memory 720 may store instructions that are to be executed by the processor 710, and may also store information associated with software and/or applications when the software and/or applications are being executed by the electronic device 700.

The camera 730 may capture a photo and/or a video, and thus-captured photo or video frame may be processed using any of the examples and embodiments described herein. The storage device 740 may include a computer-readable storage medium or computer-readable storage device. The storage device 740 may store a greater amount of information than the memory 720 and store the information for a long period of time. For example, the storage device 740 may include a magnetic hard disk, an optical disk, a flash memory, a floppy disk, or other non-volatile memories known in the art.

The input device 750 may receive input from a user through an input scheme using a keyboard and a mouse, and/or through a new input scheme such as a touch input, a voice input, and an image input. The input device 750 may include, for example, a keyboard, a mouse, a touchscreen, a microphone, and other devices that may detect an input from a user and transmit the detected input to the electronic device 700. The output device 760 may provide an output of the electronic device 700 to the user through a visual, auditory, or haptic channel. The output device 760 may include, for example, a display, a touch screen, a speaker, a vibration generator, or any other device that provides an output to a user. The network interface 770 may communicate with an external device through a wired or wireless network.

In addition, the description provided with reference to FIGS. 1 to 6 and 8 may be applied to the electronic device 700.

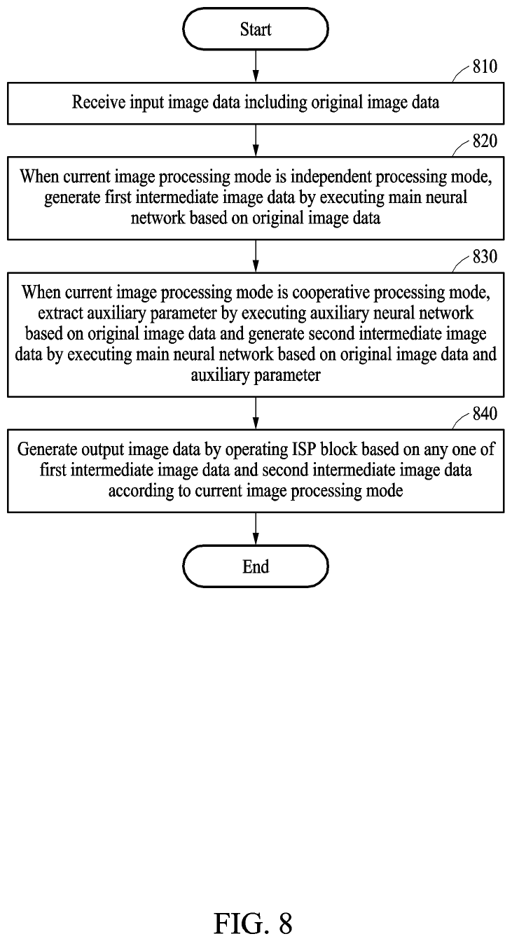

FIG. 8 illustrates an example of an image processing method based on a neural network, according to one or more embodiments. Referring to FIG. 8, in operation 810, the image processing apparatus may receive input image data including original image data. In operation 820, when the current image processing mode is the independent processing mode, the image processing apparatus may generate first intermediate image data by executing the main neural network based on the original image data. In operation 830, when the image processing apparatus receives another input image data and the current image processing mode is the cooperative processing mode, the image processing apparatus may extract an auxiliary parameter by executing an auxiliary neural network based on the original image data and generate second intermediate image data by executing the main neural network based on the original image data and the auxiliary parameter. In operation 840, the image processing apparatus may generate output image data by operating an ISP block based on any one of the first intermediate image data and the second intermediate image data according to the current image processing mode.

The main neural network may constitute a portion having an image restoration characteristic (which may correspond to an input or parameter) of the ISP pipeline and the ISP block may constitute another portion having an image enhancement characteristic (which also may correspond to an input or parameter) of the ISP pipeline.

The image processing method may further include determining a current image processing mode according to a required processing level for input image data. The determining of the current image processing mode may include determining the current image processing mode as an independent processing mode when the input image data is used as a preview or a video and determining the current image processing mode as a cooperative processing mode when the input image data is stored as a capturing result.

The auxiliary neural network may include sub-neural networks each generating different respective sub-parameters of the auxiliary parameter. The sub-neural networks may include a sub-neural network that generates a sub-parameter representing an optical diffraction state, a blur state, a detail noise state, a detail white balance state, a detail HDR state, or a degree of resource input according to a required calculation amount, and the sub-neural networks may be selectively executed according to a required processing level for input image data.

The auxiliary neural network may include a sub-neural network that generates a degradation sub-parameter representing an optical diffraction state of the input image data and/or a blur state of the input image data, the degradation sub-parameter may specify a degradation type of the input image data and/or a degradation level of the input image data, and in the cooperative processing mode, the main neural network may generate the second intermediate image data in consideration of the degradation type of input image data and/or the degradation level of input image data according to the degradation sub-parameter.

The auxiliary neural network may include a sub-neural network that generates a degradation sub-parameter representing an optical diffraction state of the input image data and/or a blur state of the input image data, the image processing method may further include generating third intermediate image data by executing a degradation restoration network based on the second intermediate image data and the degradation sub-parameter in the cooperative processing mode, and in operation 840, the image processing method may include generating output image data by operating the ISP block based on the third intermediate image data.

The auxiliary neural network may include a sub-neural network that generates a noise sub-parameter representing a detail noise state of the input image data, the noise sub-parameter may specify a noise type of the input image data and/or a noise level of the input image data, and the main neural network may generate the second intermediate image data in consideration of the noise type of input image data and/or the noise level of input image data according to a noise sub-parameter in the cooperative processing mode.

The input image data may include metadata having information on the noise state of the input image data and the noise sub-parameter may represent the noise state of the input image data with finer granularity than the metadata.

The auxiliary neural network may include a sub-neural network that generates an enhancement sub-parameter representing a detail white balance state of the input image data and/or detail of a HDR state of the input image data, and in operation 840, the image processing method may include operating the ISP block by inputting the enhancement sub-parameter into the ISP block.

The auxiliary neural network may include a sub-neural network that generates a calculation sub-parameter representing a degree of resource input according to a required calculation amount of the input image data and an operation degree of the main neural network and/or the ISP block.

The auxiliary neural network may include sub-neural networks that generate sub-parameters of the auxiliary parameter and the plurality of sub-neural networks may generate the sub-parameters in parallel. The main neural network may be executed by a first processing element, sub-neural networks of the auxiliary neural network may be executed by a sub-processing element of a second processing element, and the first processing element, the second processing element, and the ISP block may be classified from each other as hardware (i.e., may be executed in parallel by respective different hardware elements).

In addition, the descriptions provided with reference to FIGS. 1 to 7 may be applied to the image processing method of FIG. 8.

The computing apparatuses, the electronic devices, the processors, the memories, the image sensors, the displays, the information output system and hardware, the storage devices, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of image processing based on a neural network, the method comprising:
receiving input image data comprising original image data;
when a current image processing mode is an independent processing mode, generating first intermediate image data by executing a main neural network based on the original image data and by not executing an auxiliary neural network based on the original image data;
when the current image processing mode is in a cooperative processing mode, generating second intermediate image data by
determining an auxiliary parameter by executing the auxiliary neural network based on the original image data and by
executing the main neural network based on the original image data and based on the auxiliary parameter; and
generating output image data by operating an image signal processing (ISP) block based the first intermediate image data or the second intermediate image data according to the current image processing mode.

2. The method of claim 1, wherein the main neural network is configured to constitute a stage of an ISP pipeline that performs an image restoration characteristic, and
wherein the ISP block is configured to constitute another stage of the ISP pipeline having an image enhancement characteristic.

3. The method of claim 1, further comprising:
determining the current image processing mode according to a required processing level for the input image data.

4. The method of claim 3, wherein the determining of the current image processing mode comprises:
changing the current image processing mode to the independent processing mode when the input image data is used as a preview or a video; and
changing the current image processing mode to the cooperative processing mode when the input image data is stored as a capturing result.

5. The method of claim 1, wherein the auxiliary neural network comprises sub-neural networks each configured to generate respective different sub-parameters of the auxiliary parameter.

6. The method of claim 5, wherein the sub-neural networks comprise:
a sub-neural network configured to generate a sub-parameter representing an optical diffraction state, a blur state, a detail noise state, a detail white balance state, detail of a high dynamic range (HDR) state, or a degree of resource input according to a required calculation amount, and
wherein the sub-neural networks are configured to be selectively executed according to a required processing level for the input image data.

7. The method of claim 1, wherein the auxiliary neural network comprises:
a sub-neural network configured to generate a degradation sub-parameter representing an optical diffraction state of the input image data or a blur state of the input image data,
wherein the degradation sub-parameter is configured to specify a degradation type of the input image data or a degradation level of the input image data, and
wherein the main neural network is configured to generate the second intermediate image data in consideration of the degradation type of the input image data or the degradation level of the input image data according to the degradation sub-parameter in the cooperative processing mode.

8. The method of claim 1, wherein the auxiliary neural network comprises: a sub-neural network configured to generate a degradation sub-parameter representing an optical diffraction state of the input image data or a blur state of the input image data,
wherein the method further comprises: generating third intermediate image data by executing a degradation restoration network based on the second intermediate image data and the degradation sub-parameter in the cooperative processing mode, and
wherein the generating of the output image data comprises: generating the output image data by operating the ISP block based on the third intermediate image data.

9. The method of claim 1, wherein the auxiliary neural network comprises: a sub-neural network configured to generate a noise sub-parameter representing a detail noise state of the input image data,
wherein the noise sub-parameter is configured to specify a noise type of the input image data or a noise level of the input image data, and
wherein the main neural network is configured to generate the second intermediate image data in consideration of the noise type of the input image data or the noise level of the input image data according to the noise sub-parameter in the cooperative processing mode.

10. The method of claim 9, wherein the input image data further comprises metadata having information on a noise state of the input image data, and
wherein the noise sub-parameter is configured to represent the noise state of the input image data with finer granularity than the metadata.

11. The method of claim 1, wherein the auxiliary neural network comprises: a sub-neural network configured to generate an enhancement sub-parameter representing a detail white balance state of the input image data or detail of an HDR state of the input image data, and
wherein the generating of the output image data comprises operating the ISP block by inputting the enhancement sub-parameter into the ISP block.

12. The method of claim 1, wherein the auxiliary neural network comprises: a sub-neural network configured to generate a calculation sub-parameter representing a degree of resource input according to a required calculation amount of the input image data; and
wherein an operation degree of the main neural network or the ISP block is determined by the calculation sub-parameter.

13. The method of claim 1, wherein the auxiliary neural network comprises sub-neural networks configured to generate respective sub-parameters of the auxiliary parameter, and
wherein the sub-neural networks are configured to generate the respective sub-parameters in parallel.

14. The method of claim 13, wherein the main neural network is configured to be executed by a first processing element,
wherein the sub-neural networks are configured to be executed by a sub-processing element of a second processing element; and
wherein the first processing element, the second processing element, and the ISP block are distinct hardware elements.

15. An image processing apparatus, the apparatus comprising:
a processing block configured to:
receive input image data comprising original image data;
when a current image processing mode of the apparatus is an independent processing mode, generate first intermediate image data by executing a main neural network based on the original image data and by not executing an auxiliary neural network based on the original image data;
when the current image processing mode of the apparatus is in a cooperative processing mode, extract an auxiliary parameter by executing the auxiliary neural network based on the original image data;
generate second intermediate image data by executing the main neural network based on the original image data and based on the auxiliary parameter; and
an ISP block configured to:
generate output image data based on the first intermediate image data when the current image processing mode is the independent processing mode, and
generate the output image data based on the second intermediate image data when the current image processing mode is the cooperative processing mode.

16. The apparatus of claim 15, further configured to:
change the current image processing mode to the independent processing mode when the input image data is used as a preview or a video; and
change the current image processing mode to the cooperative processing mode when the input image data is stored as a capturing result.

17. The apparatus of claim 15, wherein the auxiliary neural network comprises sub-neural networks each configured to respectively generate different sub-parameters of the auxiliary parameter.

18. The apparatus of claim 15, wherein the sub-neural networks of the auxiliary neural network comprise:
a sub-neural network configured to generate a sub-parameter representing an optical diffraction state, a blur state, a detail noise state, a white balance state, an HDR state, or a degree of resource input according to a required calculation amount,
wherein the sub-neural networks are configured to be selectively executed according to a required processing level for the input image data.

19. A method comprising:
executing an ISP pipeline comprising a main neural network stage, an ISP stage, and an auxiliary neural network stage, the image processing pipeline configured to alternate between operating in a first mode and a second mode;
when the image processing pipeline is operating in the first mode and when the image processing pipeline is operating in the second mode:
generating, by the main neural network stage, intermediate images based on the respective input images; and
providing the intermediate images to the ISP stage;
when the pipeline is in the second mode and is not in the first mode:
processing the input images by the auxiliary neural network stage to generate respective auxiliary parameters; and
providing the auxiliary parameters to the main neural network stage as an additional basis used by the main neural network stage to generate the intermediate images.

20. The method according to claim 19, wherein the main neural network stage does not generate the intermediate images based on the auxiliary parameters when the image processing pipeline is in the first mode, wherein the main neural network stage performs image restoration on the input images to generate the intermediate images, and wherein the ISP stage performs image enhancement on the intermediate images.
